(19) United States
(12) Patent Application Publication
(10) Pub. No.: US 2023/0156210 A1
(43) Pub. Date: May 18, 2023

(54) IMAGE ENCODING/DECODING METHOD AND APPARATUS BASED ON PICTURE SPLIT INFORMATION AND SUBPICTURE INFORMATION, AND RECORDING MEDIUM STORING BITSTREAM

(71) Applicant: LG Electronics Inc., Seoul (KR)

(72) Inventors: Hendry HENDRY, Seoul (KR); Seung Hwan KIM, Seoul (KR); Seethal PALURI, Seoul (KR)

(21) Appl. No.: 17/916,227

(22) PCT Filed: Mar. 31, 2021
(86) PCT No.: PCT/KR2021/004029

§ 371 Date: Sep. 30, 2022

Related U.S. Application Data
(60) Provisional application No. 63/003,247, filed on Mar. 31, 2020.

(51) Int. Cl. H04N 19/46; H04N 19/172

(52) U.S. Cl. CPC H04N 19/46; H04N 19/172

(57) ABSTRACT

Provided is an image encoding/decoding method and apparatus. The image decoding method may include obtaining first information on whether a current picture might be partitioned, from a bitstream, obtaining, from the bitstream, second information on the number of one or more subpictures included in the current picture based on the first information, deriving one or more subpictures, based on the second information and decoding the one or more subpictures.

### TECHNICAL FIELD

The present disclosure relates to an image encoding/decoding method and apparatus, and, more particularly, to an image encoding and decoding method and apparatus based on picture partitioning information and subpicture information, and a recording medium storing a bitstream.

### BACKGROUND ART

Recently, demand for high-resolution and high-quality images such as high definition (HD) images and ultra high definition (UHD) images is increasing in various fields. As resolution and quality of image data are improved, the amount of transmitted information orbits relatively increases as compared to existing image data. An increase in the amount of transmitted information or bits causes an increase in transmission cost and storage cost.

Accordingly, there is a need for high-efficient image compression technology for effectively transmitting, storing and reproducing information on high-resolution and high-quality images.

### DISCLOSURE

### Technical Problem

An object of the present disclosure is to provide an image encoding/decoding method and apparatus with improved encoding/decoding efficiency.

Another object of the present disclosure is to provide an image encoding/decoding method and apparatus based on picture partitioning information and subpicture information in a syntax.

Another object of the present disclosure is to provide an image encoding/decoding method and apparatus based on subpicture information signalled based on picture partitioning information.

Another object of the present disclosure is to provide a computer-readable recording medium storing a bitstream generated by an image encoding method or apparatus according to the present disclosure.

Another object of the present disclosure is to provide ide a computer-readable recording medium storing a bitstream received, decoded and used to reconstruct an image by an image decoding apparatus according to the present disclosure.

Another object of the present disclosure is to provide a method of transmitting a bitstream generated by an image encoding method or apparatus according to the present disclosure.

The technical problems solved by the present disclosure are not limited to the above technical problems and other technical problems which are not described herein will become apparent to those skilled in the art from the following description.

### Technical Solution

An image decoding method according to an aspect of the present disclosure may comprise obtaining first information on whether a current picture might be partitioned, from a bitstream, obtaining, from the bitstream, second information on the number of one or more subpictures included in the current picture based on the first information, deriving one or more subpictures, based on the second information, and decoding the one or more subpictures.

An image decoding apparatus according to another aspect of the present disclosure may comprise a memory and at least one processor, wherein the at least one processor is configured to: obtain first information on whether a current picture is partitioned, from a bitstream, obtain from the bitstream, second information on the number of one or more subpictures included in the current picture based on the first information, derive one or more subpictures, based on the second information, and decode the one or more subpictures.

An image encoding method according to another aspect of the present disclosure may comprise deriving one or more subpictures included in a current picture, encoding first information indicating whether the current picture might be partitioned, based on a number of the one or more subpictures, and encoding second information on the number of the one or more subpictures, based on the first information.

A computer-readable recording medium according to another aspect of the present disclosure may store the bitstream generated by the image encoding apparatus or the image encoding method of the present disclosure.

A transmission method according to another aspect of the present disclosure may transmit a bitstream generated by the image encoding apparatus or the image encoding method of the present disclosure.

The features briefly summarized above with respect to the present disclosure are merely exemplary aspects of the detailed description below of the present disclosure, and do not limit the scope of the present disclosure.

### Advantageous Effects

According to the present disclosure, it is possible to provide an image encoding/decoding method and apparatus with improved encoding/decoding efficiency.

Also, according to the present disclosure, it is possible to provide an image encoding/decoding method and apparatus based on picture partitioning information and subpicture information in a syntax.

Also, according to the present disclosure, it is possible to provide an image encoding/decoding method and apparatus based on subpicture information signalled based on picture partitioning information.

Also, according to the present disclosure, it is possible to provide a computer-readable recording medium storing a bitstream generated by an image encoding method or apparatus according to the present disclosure.

Also, according to the present disclosure, it is possible to provide a computer-readable recording medium storing a bitstream received, decoded and used to reconstruct an image by an image decoding apparatus according to the present disclosure.

Also, according to the present disclosure, it is possible to provide a method of transmitting a bitstream generated by an image encoding method or apparatus according to the present disclosure.

It will be appreciated by persons skilled in the art that that the effects that can be achieved through the present disclosure are not limited to what has been particularly described hereinabove and other advantages of the present disclosure will be more clearly understood from the detailed description.

### BRIEF DESCRIPTION OF THE DRAWINGS

FIG. 1 is a view schematically illustrating a video coding system, to which an embodiment of the present disclosure is applicable.

FIG. 2 is a view schematically illustrating an image encoding apparatus, to which an embodiment of the present disclosure is applicable.

FIG. 3 is a view schematically illustrating an image decoding apparatus, to which an embodiment of the present disclosure is applicable.

FIG. 4 is a view illustrating an example of an SPS.

FIG. 5 is a view illustrating an example of a PPS.

FIG. 6 is a view illustrating an example of a slice header.

FIG. 7 to FIG. 9 is a view illustrating a PPS according to an embodiment of the present disclosure.

FIG. 10 is a flowchart illustrating an image encoding method according to an embodiment of the present disclosure.

FIG. 11 is a flowchart illustrating an image decoding method according to an embodiment of the present disclosure.

FIG. 12 is a view illustrating a content streaming system, to which an embodiment of the present disclosure is applicable.

### MODE FOR INVENTION

Hereinafter, the embodiments of the present disclosure will be described in detail with reference to the accompanying drawings so as to be easily implemented by those skilled in the art. However, the present disclosure may be implemented in various different forms, and is not limited to the embodiments described herein.

In describing the present disclosure, if it is determined that the detailed description of a related known function or construction renders the scope of the present disclosure unnecessarily ambiguous, the detailed description thereof will be omitted. In the drawings, parts not related to the description of the present disclosure are omitted, and similar reference numerals are attached to similar parts.

In the present disclosure, when a component is “connected”, “coupled” or “linked” to another component, it may include not only a direct connection relationship but also an indirect connection relationship in which an intervening component is present. In addition, when a component “includes” or “has” other components, it means that other components may be further included, rather than excluding other components unless otherwise stated.

In the present disclosure, the terms first, second, etc. may be used only for the purpose of distinguishing one component from other components, and do not limit the order or importance of the components unless otherwise stated. Accordingly, within the scope of the present disclosure, a first component in one embodiment may be referred to as a second component in another embodiment, and similarly, a second component in one embodiment may be referred to as a first component in another embodiment.

In the present disclosure, components that are distinguished from each other are intended to clearly describe each feature, and do not mean that the components are necessarily separated. That is, a plurality of components may be integrated and implemented in one hardware or software unit, or one component may be distributed and implemented in a plurality of hardware or software units. Therefore, even if not stated otherwise, such embodiments in which the components are integrated or the component is distributed are also included in the scope of the present disclosure.

In the present disclosure, the components described in various embodiments do not necessarily mean essential components, and some components may be optional components. Accordingly, an embodiment consisting of a subset of components described in an embodiment is also included in the scope of the present disclosure. In addition, embodiments including other components in addition to components described in the various embodiments are included in the scope of the present disclosure.

The present disclosure relates to encoding and decoding of an image, and term used in the present disclosure may have a general meaning commonly used in the technical field, to which the present disclosure belongs, unless newly defined in the present disclosure.

In the present disclosure, a “picture” generally refers to a unit representing one image in a specific time period, and a slice/tile is a coding unit constituting a part of a picture, and one picture may be composed of one or more slices/tiles. In addition, a slice/tile may include one or more coding tree units (CTUs).

In the present disclosure, a “pixel” or a “pel” may mean a smallest unit constituting one picture (or image). In addition “sample” may be used as a term corresponding to a pixel. A sample may generally represent a pixel or a value of a pixel, and may represent only a pixel/pixel value of a luma component or only a pixel/pixel value of a chroma component.

In the present disclosure, a “unit” may represent a basic unit of image processing. The unit may include at least one of a specific region of the picture and information related to the region. The unit may be used interchangeably with terms such as “sample array”, “block” or “area” in some cases. In a general case, an M×N block may include samples (or sample arrays) or a set (or array) of transform coefficients of M columns and N rows.

In the present disclosure, “current block” may mean one of “current coding block”, “current coding unit”, “coding target block”. “decoding target block” or “processing target block”. When prediction is performed. “current block” may mean “current prediction block” or “prediction target block”. When transform (inverse transform)/quantization (dequantization) is performed, “current block” may mean“current transform block” or “transform target block”. When filtering is performed, “current block” may mean “filtering target block”.

In addition, in the present disclosure, a “current block” may mean a block including both a luma component block and a chroma component block or “a luma block of a current block” unless explicitly stated as a chroma block. The luma component block of the current block may be expressed by including an explicit description of a luma component block such as “luma block” or “current luma block. In addition, the “chroma component block of the current block” may be expressed by including an explicit description of a chroma component block, such as “chroma block” or “current chroma block”.

In the present disclosure, the term “/” and “,” should be interpreted to indicate “and/or.” For instance, the expression “A/B” and “A, B” may mean “A and/or B.” Further, “A/B/C” and “AB/C” may mean “at least one of A, B, and/or C.”

In the present disclosure, the term “or” should be interpreted to indicate “and/or.” For instance, the expression “A or B” may comprise 1) only “A”, 2) only “B”, and/or 3) both “A and B”. In other words, in the present disclosure, the term “or” should be interpreted to indicate “additionally or alternatively.”

Overview of Video Coding System

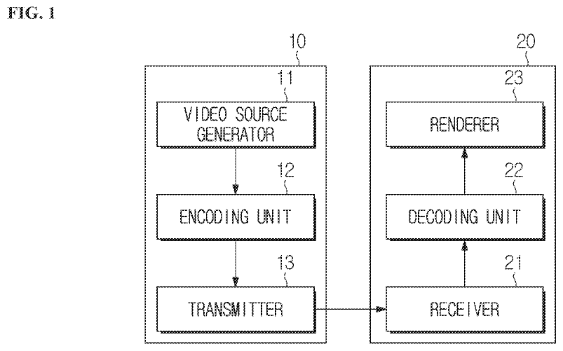

FIG. 1 is a view schematically illustrating a video coding system, to which an embodiment of the present disclosure is applicable.

The video coding system according to an embodiment may include a encoding apparatus 10 and a decoding apparatus 20. The encoding apparatus 10 may deliver encoded video and/or image information or data to the decoding apparatus 20 in the form of a file or streaming via a digital storage medium or network.

The encoding apparatus 10 according to an embodiment may include a video source generator 11, an encoding unit 12 and a transmitter 13. The decoding apparatus 20 according to an embodiment may include a receiver 21, a decoding unit 22 and a renderer 23. The encoding unit 12 may be called a vide/image encoding unit, and the decoding unit 22 may be called a video/image decoding mit. The transmitter 13 may be included in the encoding unit 12. The receiver 21 may be included in the decoding unit 22. The renderer 23 may include a display and the display may be configured as a separate device or an extremal component.

The video source generator 11 may acquire a video/image through a process of capturing, synthesizing or generating the video/image. The video source generator 11 may include a video/image capture device and/or a video/image generating device. The video/image capture device may include, for example, one or more cameras, vide/image archives including previously captured video/images, and the like. The video/image generating device may include, for example, computers, tablets and smartphones, and may (electronically) generate vide/images. For example, a virtual video/image may be generated through a computer or the like. In this case, the vide/image capturing process may be replaced by a process of generating related data.

The encoding unit 12 may encode an input vide/image. The encoding unit 12 may perform a series of procedures such as prediction, transform, and quantization for compression and coding efficiency. The encoding unit 12 may output e coded data (encoded video/image information) in the form of a bitstream.

The transmitter 13 may transmit the encoded video/image information or data output in the form of a bitstream to the receiver 21 of the decoding apparatus 20 through a digital storage medium or a network in the form of a file or streaming. The digital storage medium may include various storage mediums such as USB, SD, CD, DVD, Blu-ray, HDD, SSD, and the like. The transmitter 13 may include an element for generating a media file through a predetermined file format and may include an element for transmission through a broadcast/communication network. The receiver 21 may extract/receive the bitstream from the storage medium or network and transmit the bitstream to the decoding unit 22.

The decoding unit 22 may decode the video/image by performing a series of procedures such as dequantization, inverse transform, and prediction corresponding to the operation of the encoding unit 12.

The renderer 23 may render the decoded video/image. The rendered video/image may be displayed through the display.

Overview of Huge Encoding Apparatus

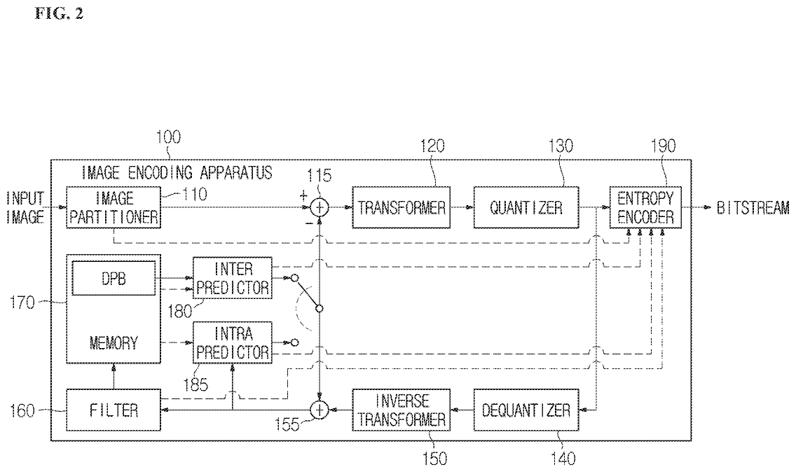

FIG. 2 is a view schematically illustrating an image encoding apparatus, to which an embodiment of the present disclosure is applicable.

As shown in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185 and an entropy encoder 190. The inter predictor 180 and the intra predictor 185 may be collectively referred to as a “predictor”. The transformer 120, the quantizer 130, the dequantizer 140 and the inverse transformer 150 may be included in a residual processor. The residual processor may further include the subtractor 115.

All or at least some of the plurality of components configuring the image encoding apparatus 100 may be configured by one hardware component (e.g., a encoder or a processor) in some embodiments. In addition, the memory 170 may include a decoded picture buffer (DPB) and may be configured by a digital storage medium.

The image partitioner 110 may partition an input image (or a picture or a frame) input to the image encoding apparatus 100 into one or more processing units. For example, the processing unit may be called a coding unit (CU). The coding unit may be acquired by recursively partitioning a coding tree unit (CTU) or a largest coding unit (LCU) according to a quad-tree binary-tree temary-tree (QT/BT/TT) structure. For example, one coding unit may be partitioned into a plurality of coding units of a deeper depth based on a quad tree structure, a binary tree structure, and/or a temary structure. For partitioning of the coding unit, a quad tree structure may be applied first and the binary tree structure and/or temary structure may be applied later. The coding procedure according to the present disclosure may be performed based on the final coding unit that is no longer partitioned. The largest coding unit may be used as the final coding unit or the coding unit of deeper depth acquired by partitioning the largest coding unit may be used as the final coding unit. Here, the coding procedure may include a procedure of prediction, transform and reconstruction, which will be described later. As another example, the processing unit of the coding procedure may be a prediction unit (PU) or a transform unit (TU). The prediction unit and the transform unit may be split or partitioned from the final coding unit. The prediction unit may be a unit of sample prediction, and the transform unit may be a unit for deriving a transform coefficient and/or a unit for deriving a residual signal from the transform coefficient.

The predictor (the inter predictor 180 or the intra predictor 185) may perform prediction on a block to be processed (current block) and generate a predicted block including prediction samples for the current block. The predictor may determine whether intra prediction or inter prediction is applied on a current block or CU basis. The predictor may generate various information related to prediction of the current block and transmit the generated information to the entropy encoder 190. The information on the prediction may be encoded in the entropy encoder 190 and output in the form of a bitstream.

The intra predictor 185 may predict the current block by referring to the samples in the current picture. The referred samples may be located in the neighborhood of the current block or may be located apart according to the intra prediction mode and/or the intra prediction technique. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes according to the degree of detail of the prediction direction. However, this is merely an example, more or less directional prediction modes may be used depending on a setting. The intra predictor 185 may determine the prediction mode applied to the current block by using a prediction mode applied to a neighboring block.

The inter predictor 180 may derive a predicted block for the current block based on a reference block (reference sample array) specified by a motion vector on a reference picture. In this case, in order to reduce the amount of motion information transmitted in the inter prediction mode, the motion information may be predicted in units of blocks, subblocks, or sample s based on correlation of motion information between the neighboring block and the current block. The motion information may include a motion vector and a reference picture index. The motion information may further include inter prediction direction (L0 prediction, L1 prediction. Bi prediction, etc.) information. In the case of inter prediction, the neighboring block may include a spatial neighboring block present in the current picture and a temporal neighboring block present in the reference picture. The reference picture including the reference block and the reference picture including the temporal neighboring block may be the same or different. The temporal neighboring block may be called a collocated reference block, a co-located CU (colCU and the like. The reference picture including the temporal neighboring block may be called a collocated picture (colPic). For example, the inter predictor 180 may configure a motion information candidate list based on neighboring blocks and generate information indicating which candidate is used to derive a motion vector and/or a reference picture index of the current block. Inter prediction may be performed based on various prediction modes. For example, in the case of a skip mode and a merge mode, the inter predictor 180 may use motion information of the neighboring block as motion information of the current block. In the case of the skip mode, unlike the merge mode, the residual signal may not be transmitted. In the case of the motion vector prediction (MVP) mode, the motion vector of the neighboring block may be used as a motion vector predictor, and the motion vector of the current block may be signaled by encoding a motion vector difference and an indicator for a motion vector predictor. The motion vector difference may mean a difference between the motion vector of the current block and the motion vector predictor.

The predictor may generate a prediction signal based on various prediction methods and prediction techniques described below. For example, the predictor may not only apply intra prediction or inter prediction but also simultaneously apply both intra prediction and inter prediction, in order to predict the current block. A prediction method of simultaneously applying both intra prediction and inter prediction for prediction of the current block may be called combined inter and intra prediction (CUP). In addition, the predictor may perform intra block copy (IBC) for prediction of the current block. Intra block copy may be used for content image/video coding of a game or the like, for example, screen content coding (SCC). IBC is a method of predicting a current picture using a previously reconstructed reference block in the current picture at a location apart from the current block by a predetermined distance. When IBC is applied, the location of the reference block in the current picture may be encoded as a vector (block vector) corresponding to the predetermined distance. IBC basically performs prediction in the current picture, but may be performed similarly to inter prediction in that a reference block is derived within the current picture. That is, IBC may use at least one of the inter prediction techniques described in the present disclosure.

The prediction signal generated by the predictor may be used to generate a reconstructed signal or to generate a residual signal. The subtractor 115 may generate a residual signal (residual block or residual sample array) by subtracting the prediction signal (predicted block or prediction sample array) output from the predictor from the input image signal (original block or original sample array). The generated residual signal may be transmitted to the transformer 120.

The transformer 120 may generate transform coefficients by applying a transform technique to the residual signal. For example, the transform technique may include at least one of a discrete cosine transform (DCT), a discrete sine transform (DST), a karhunen-loève transform (KLT), a graph-based transform (GBT), or a conditionally non-linear transform (CNT). Here, the GBT means transform obtained from a graph when relationship information between pixels is represented by the graph. The CNT refers to transform acquired based on a prediction signal generated using all previously reconstructed pixels. In addition, the transform process may be applied to square pixel blocks having the same size or may be applied to blocks having a variable size rather than square.

The quantizer 130 may quantize the transform coefficients and transmit them to the entropy encoder 190. The entropy encoder 190 may encode the quantized signal (information on the quantized transform coefficients) and output a bitstream. The information on the quantized transform coefficients may be referred to as residual information. The quantizer 130 may rearrange quantized transform coefficients in a block type into a one-dimensional vector form based on a coefficient scanning order and generate information on the quantized transform coefficients based on the quantized transform coefficients in the one-dimensional vector form.

The entropy encoder 190 may perform various encoding methods such as, for example, exponential Golomb, context-adaptive variable length coding (CAVLC), context-adaptive binary arithmetic coding (CABAC), and the like. The entropy encoder 190 may encode information necessary for video/image reconstruction other than quantized transform coefficients (e.g., values of syntax elements, etc.) together or separately. Encoded information (e.g., encoded video/image information) may be transmitted or stored in units of network abstraction layers (NALs) in the form of a bitstream. The video/image information on may further include information on various parameter sets such as an adaptation parameter set (APS), a picture parameter set (PPS), a sequence parameter set (SPS), or a video parameter set (VPS). In addition, the video/image information may further include general constraint information. The signaled information, transmitted information and/or syntax elements described in the present disclosure may be encoded through the above-described encoding procedure and included in the bitstream.

The bitstream may be transmitted over a network or may be stored in a digital storage medium. The network may include a broadcasting network and/or a communication network, and the digital storage medium may include various storage media such as USB, SD, CD, DVD, Blu-ray, HDD, SSD, and the like. A transmitter (not shown) transmitting a signal output from the entropy encoder 190 and/or a storage unit (not shown) storing the signal may be included as internal/extremal element of the image encoding apparatus 100. Alternatively, the transmitter may be provided as the component of the entropy encoder 190.

The quantized transform coefficients output from the quantizer 130 may be used to generate a residual signal. For example, the residual signal (residual block or residual samples) may be reconstructed by applying dequantization and inverse transform to the quantized transform coefficients through the dequantizer 140 and the inverse transformer 150.

The adder 155 adds the reconstructed residual signal to the prediction signal output from the inter predictor 180 or the intra predictor 185 to generate a reconstructed signal (reconstructed picture, reconstructed block, reconstructed sample array). If there is no residual for the block to be processed, such as a case where the skip mode is applied, the predicted block may be used as the reconstructed block. The adder 155 may be called a reconstructor or a reconstructed block generator. The generated reconstructed signal may be used for intra prediction of a next block to be processed in the current picture and may be used for inter prediction of a next picture through filtering as described below.

The filter 160 may improve subjective/objective image quality by applying filtering to the reconstructed signal. For example, the filter 160 may generate a modified reconstructed picture by applying various filtering methods to the reconstructed picture and store the modified reconstructed picture in the memory 170, specifically, a DPB of the memory 170. The various filtering methods may include, for example, deblocking filtering, a sample adaptive offset, an adaptive loop filter, a bilateral filter, and the like. The filter 160 may generate various information related to filtering and transmit the generated information to the entropy encoder 190 as described later in the description of each filtering method. The information related to filtering may be encoded by the entropy encoder 190 and output in the form of a bitstream.

The modified reconstructed picture transmitted to the memory 170 may be used as the reference picture in the inter predictor 180. When inter prediction is applied through the image encoding apparatus 100, prediction mismatch between the image encoding apparatus 100 and the image decoding apparatus may be avoided and encoding efficiency may be improved.

The DPB of the memory 170 may store the modified reconstructed picture for use as a reference picture in the inter predictor 180. The memory 170 may store the motion information of the block fron which the motion information in the current picture is derived (or encoded) and/or the motion information of the blocks in the picture that have already been reconstructed. The stored motion information may be transmitted to the inter predictor 180 and used as the motion information of the spatial neighboring block or the motion information of the temporal neighboring block. The memory 170 may store reconstructed samples of reconstructed blocks in the current picture and may transfer the reconstructed samples to the intra predictor 185.

Overview of Image Decoding Apparatus

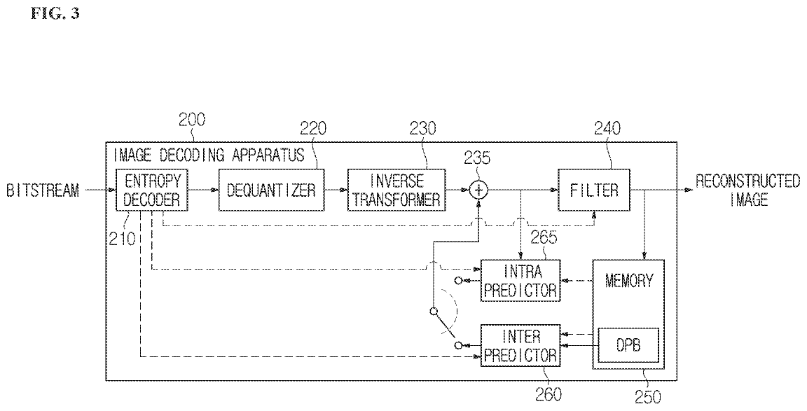

FIG. 3 is a view schematically illustrating an image decoding apparatus, to which an embodiment of the present disclosure is applicable.

As shown in FIG. 3, the image decoding apparatus 200 may include an entropy decoder 210, a dequantizer 220, an inverse transformer 230, an adder 235, a filter 240, a memory 250, an inter predictor 260 and an intra predictor 265. The inter predictor 260 and the intra predictor 265 may be collectively referred to as a “predictor”. The dequantizer 220 and the inverse transformer 230 may be included in a residual processor.

All or at least some of a plurality of components configuring the image decoding apparatus 200 may be configured by a hardware component (e.g., a decoder or a processor) according to an embodiment. In addition, the memory 250 may include a decoded picture buffer (DPB) or may be configured by a digital storage medium.

The image decoding apparatus 200, which has received a bitstream including video/image information, may reconstruct an image by performing a process corresponding to a process performed by the image encoding apparatus 100 of FIG. 2. For example, the image decoding apparatus 200 may perform decoding using a processing unit applied in the image encoding apparatus. Thus, the processing unit of decoding may be a coding unit, for example. The coding unit may be acquired by partitioning a coding tree unit or a largest coding unit. The reconstructed image signal decoded and output through the image decoding apparatus 200 may be reproduced through a reproducing apparatus (not shown).

The image decoding apparatus 200 may receive a signal output from the image encoding apparatus of FIG. 2 in the form of a bitstream. The received signal may be decoded through the entropy decoder 210. For example, the entropy decoder 210 may parse the bitstream to derive information (e.g., video/image information) necessary for image reconstruction (or picture reconstruction). The video/image information may further include information on various parameter sets such as an adaptation parameter set (APS), a picture parameter set (PPS), a sequence parameter set (SPS), or a video parameter set (VPS). In addition, the video/image information may further include general constraint information. The image decoding apparatus may further decode picture based on the information on the parameter set and/or the general constraint information. Signaled/received information and/or syntax elements described in the present disclosure may be decoded through the decoding procedure and obtained from the bitstream. For example, the entropy decoder 210 decodes the information in the bitstream based on a coding method such as exponential Golomb coding, CAVLC, or CABAC, and output values of syntax elements required for image reconstruction and quantized values of transform coefficients for residual. More specifically, the CABAC entropy decoding method may receive a bin corresponding to each syntax element in the bitstream, determine a context model using a decoding target syntax element information, decoding information of a neighboring block and a decoding target block or information of a symbol/bin decoded in a previous stage, and perform arithmetic decoding on the bin by predicting a probability of occurrence of a bin according to the determined context model, and generate a symbol corresponding to the value of each syntax element. In this case, the CABAC entropy decoding method may update the context model by using the information of the decoded symbol/bin for a context model of a next symbol/bin after determining the context model. The information related to the prediction among the information decoded by the entropy decoder 210 may be provided to the predictor (the inter predictor 260 and the intra predictor 265), and the residual value on which the entropy decoding was performed in the entropy decoder 210, that is, the quantized transform coefficients and related parameter information, may be input to the dequantizer 220. In addition, information on filtering among information decoded by the entropy decoder 210 may be provided to the filter 240. Meanwhile, a receiver (not shown) for receiving a signal output from the image encoding apparatus may be further configured as an internal/extremal element of the image decoding apparatus 200, or the receiver may be a component of the entropy decoder 210. [82] Meanwhile, the image decoding apparatus according to the present disclosure may be referred to as a video/image/picture decoding apparatus. The image decoding apparatus may be classified into an information decoder (video/image/picture information decoder) and a sample decoder (video/image/picture sample decoder). The information decoder may include the entropy decoder 210. The sample decoder may include at least one of the dequantizer 220, the inverse transformer 230, the adder 235, the filter 240, the memory 250, the inter predictor 160 or the intra predictor 265.

The dequantizer 220 may dequantize the quantized transform coefficients and output the transform coefficients. The dequantizer 220 may rearrange the quantized transform coefficients in the form of a two-dimensional block. In this case, the rearrangement may be performed based on the coefficient scanning order performed in the image encoding apparatus. The dequantizer 220 may perform dequantization on the quantized transform coefficients by using a quantization parameter (e.g., quantization step size information) and obtain transform coefficients.

The inverse transformer 230 may inversely transform the transform coefficients to obtain a residual signal (residual block, residual sample array).

The predictor nay perform prediction on the current block and generate a predicted block including prediction samples for the current block. The predictor may determine whether intra prediction or inter prediction is applied to the current block based on the information on the prediction output from the entropy decoder 210 and may determine a specific intra/inter prediction mode (prediction technique).

It is the same as described in the predictor of the image encoding apparatus 100 that the predictor may generate the prediction signal based on various prediction methods (techniques) which will be described later.

The intra predictor 265 may predict the current block by referring to the samples in the current picture. The description of the intra predictor 185 is equally applied to the intra predictor 265.

The inter predictor 260 may derive a predicted block for the current block based on a reference block (reference sample array) specified by a motion vector on a reference picture. In this case, in order to reduce the amount of motion information transmitted in the inter prediction mode, motion information may be predicted in units of blocks, subblocks, or samples based on correlation of motion information between the neighboring block and the current block. The motion information may include a motion vector and a reference picture index. The motion information may further include inter prediction direction (L0 prediction, L1 prediction, Bi prediction, etc.) information. In the case of inter prediction, the neighboring block may include a spatial neighboring block present in the current picture and a temporal neighboring block present in the reference picture. For example, the inter predictor 260 may configure a motion information candidate list based on neighboring blocks and derive a motion vector of the current block and/or a reference picture index based on the received candidate selection information. Inter prediction may be performed based on various prediction modes, and the information on the prediction may include information indicating a mode of inter prediction for the current block.

The adder 235 may generate a reconstructed signal (reconstructed picture, reconstructed block, reconstructed sample array) by adding the obtained residual signal to the prediction signal (predicted block, predicted sample array) output from the predictor (including the inter predictor 260 and/or the intra predictor 265). If there is no residual for the block to be processed, such as when the skip mode is applied, the predicted block may be used as the reconstructed block. The description of the adder 155 is equally applicable to the adder 235. The adder 235 may be called a reconstructor or a reconstructed block generator. The generated reconstructed signal may be used for intra prediction of a next block to be processed in the current picture and may be used for inter prediction of a next picture through filtering as described below.

The filter 240 may improve subjective/objective image quality by applying filtering to the reconstructed signal. For example, the filter 240 may generate a modified reconstructed picture by applying various filtering methods to the reconstructed picture and store the modified reconstructed picture in the memory 250, specifically, a DPB of the memory 250. The various filtering methods may include, for example, deblocking filtering, a sample adaptive offset, an adaptive loop filter, a bilateral filter, and the like.

The (modified) reconstructed picture stored in the DPB of the memory 250 may be used as a reference picture in the inter predictor 260. The memory 250 may store the motion information of the block from which the motion information in the current picture is derived (or decoded) and/or the motion information of the blocks in the picture that have already been reconstructed. The stored motion information may be transmitted to the inter predictor 260 so as to be utilized as the motion information of the spatial neighboring block or the motion information of the temporal neighboring block. The memory 250 may store reconstructed samples of reconstructed blocks in the current picture and transfer the reconstructed samples to the intra predictor 265.

In the present disclosure, the embodiments described in the filter 160, the inter predictor 180, and the intra predictor 185 of the image encoding apparatus 100 may be equally or correspondingly applied to the filter 240, the inter predictor 260, and the intra predictor 265 of the image decoding apparatus 200.

Overview Of Image Partitioning

The video/image coding method according to the present disclosure may be performed based on an image partitioning structure as follows. Specifically, the procedures of prediction, residual processing ((inverse) transform, (de)quantization, etc.), syntax element coding, and filtering, which will be described later, may be performed based on a CTU, CU (and/or TU, PU) derived based on the image partitioning structure. The image may be partitioned in block units and the block partitioning procedure may be performed in the image partitioner 110 of the encoding apparatus. The partitioning related information may be encoded by the entropy encoder 190 and transmitted to the decoding apparatus in the form of a bitstream. The entropy decoder 210 of the decoding apparatus may derive a block partitioning structure of the current picture based on the partitioning related information obtained from the bitstream, and based on this, may perform a series of procedures (e.g. prediction, residual processing, block/picture reconstruction, in-loop filtering, etc.) for image decoding.

A CU size may be equal to a TU size or a plurality of TUs may be present in a CU region. Meanwhile, the CU size may generally indicate a luma component (sample) CB size. The TU size may generally indicate a luma component (sample) TB size. A chroma component (sample) CB or TB size may be derived based on a luma component (sample) CB or TB size according to a component ratio according to a chroma format (color format, e.g., 4:4:4, 4:2:2, 4:2:0, etc.) of a picture/image. The TU size may be derived based on maxTbSize indicating an available maximum TB size. For example, when the CU size is greater than maxTbSize, a plurality of TUs (TBs) having maxTbSize may be derived from the CU, and transform/inverse transform may be performed in unit of TU (TB). In addition, for example, when intra prediction is applied, an intra prediction mode/type may be derived in unit of CU (or CB) and a neighboring reference sample derivation and prediction sample generation procedure may be performed in unit of TU (or TB). In this case, one or a plurality of TUs (or TBs) may be present in a CU (or a CB) region. In this case, the plurality of TU s (or TBs) may share the same intra prediction mode/type.

In addition, in image encoding and decoding according to the present disclosure, an image processing unit may have a hierarchical structure. For example, one picture may be partitioned into one or more tiles or tile groups. One tile group may include one or more tiles. One tile may include one or more CTUs. The CTU may be partitioned into one or more CUs, as described above. The tile may consist of a rectangular region including CTUs assembled in a specific row and a specific column in a picture. The tile group may include an integer number of tiles according to tile-raster scan. A tile group header may signal information/parameters applicable to a corresponding tile group. When an encoding/decoding apparatus has a multi-core processor, an encoding/decoding procedure for the tile or tile group may be performed in parallel. Here, the the group may have one of tile group types including an intra (I) tile group, a predictive (P) tile group and a bi-predictive (B) the group. For blocks in the I tile group, inter prediction may not be used and only intra prediction may be used for prediction. Of course, even in this case, an original sample value may be coded and signalled without prediction. For blocks in the P tile group, intra prediction or inter prediction may be used, and only uni-prediction may be used when inter prediction. Meanwhile, for blocks in the B tile group, intra prediction or inter prediction may be used, and up to bi prediction may be used when inter prediction is used.

In an encoding apparatus, a tile/tile group, a slice, a maximum and minimum coding unit size may be determined according to the characteristics (e.g., resolution) of an image or in consideration of coding efficiency or parallel processing, and information thereon or information capable of deriving the same may be included in a bitstream.

In a decoding apparatus, information indicating whether a slice of a current picture, a tile/tile group, a CTU in a tile is partitioned into a plurality of coding units may be obtained. When such information is obtained (transmitted) only under a specific condition, efficiency can increase.

The slice header or tile group header (tile group header syntax) may include information/parameter which is commonly applicable to the slice or tile group. An APS (APS syntax) or PPS (PPS syntax) may include information/parameter which is commonly applicable to one or more pictures. The SPS (SPS syntax) may include information/parameter which is commonly applicable to one or more sequences. The VPS (VPS syntax) may include information/parameter which is commonly applicable to the overall video. In the present disclosure, a higher level syntax may include at least one of the APS syntax, the PPS syntax, the SPS syntax or the VPS syntax.

In addition, for example, information on partitioning and configuration of the tile/tile group may be constructed in an encoder through the higher level syntax and transmitted to the decoding apparatus in the form of a bitstream.

Picture Partitioning Signaling

A coded picture may consist of one or more slices. Parameters describing a coded picture are signalled within a picture header (PH) and parameters describing a slice are signalled within slice header. PH is carried in its own NAL unit type. SH is present in the beginning of a NAL unit containing payload of a slice (i.e., slice data).

VVC allows picture to be partitioned into subpictures, tiles, and/slices. Subpictures signalling is present in the SPS, tile and rectangular slice signalling are present in the PPS, and finally raster-scan slice signalling is present in the slice header.

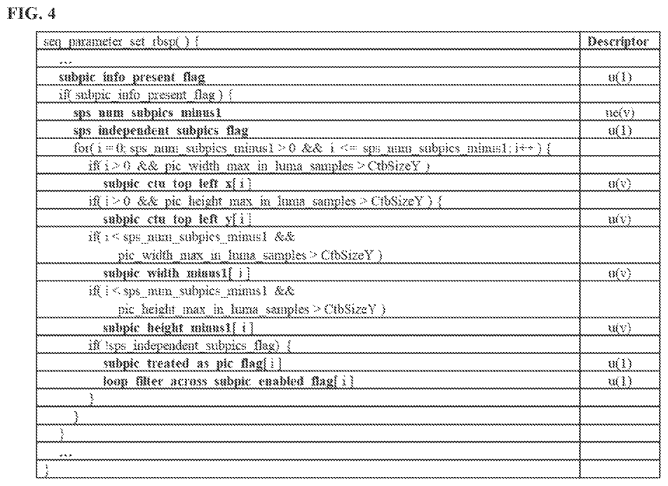

FIG. 4 is a view illustrating an example of an SPS.

Referring to FIG. 4, the SPS may include a syntax element subpic_info_present_flag. subpic_info_present_flag may specify whether there is subpicture information for a CLVS (coded layer video sequence). For example, subpic_info_present_flag equal to a first value (e.g., 1) may specify that there is subpicture information for the CLVS and there are one or more subpictures within each picture in the CLVS. In contrast, subpic_info_present_flag equal to a second value (e.g., 0) may specify that there is no subpicture information for the CLTS and there is only one subpicture within each picture in the CLVS. When res_chango_in_clvs_allowed_flag is equal to a first value (e.g., 1), the value of subpic_info_present_flag shall be equal to a second value (e.g., 0). Here, res_ change_in_clvs_allowed_flag equal to a first value (e.g., 1) may specify that picture space resolution is not changed in all CLVSs referring to the SPS.

Meanwhile, when a bitstream is the result of a sub-bitstream extraction process and contains only a subset of subpictures of the input bitstream to the sub-bitstream extraction process, it might be required to set the value of subpic_info_present_flag equal to 1 in a raw byte sequence payload (RBSP) of the SPSs.

In addition, the SPS may include a syntax element sps_num_subpics_minus1. sps_num_subpics_minus1 plus 1 may specify the number of subpictures in each picture in the CLVS. The value of sps_nunsubpics_minus1 shall be in the range of 0 to Ceil(pic_width_max_in_luma_samples+CtbSizeY)×Ceil(pic_height_max_in_luma_samples+CtbSizeY)−1, inclusive. Meanwhile, when sps_num_subpics_minus1 is not present (that is, it is not signalled), the value of sps_num_subpics_minus1 may be inferred to be equal to a first value (e.g., 0).

In addition, the SPS may include a syntax element sps_independent_subpics_flag. sps_independent_subpics_flag may specify whether a subpicture boundary is independent. For example, sps_independent_subpics_flag equal to a first value (e.g., 1) may specify that all subpicture boundaries in the CLVS are treated as picture boundaries and there is not loop filtering across the subpicture boundaries. In contrast, sps_independent_subpics_flag equal to a second value (e.g., 0) may specify that such a constraint is not imposed. When sps_independent_subpics_flag is not present, the value of sps_independent_subpics_flag may be inferred to be equal to a second value (e.g., 0).

In addition, the SPS may include a syntax element subpic_treated_as_pic_flag[i]. subpic_treated_as_pic_flag[i] may specify whether a subpicture is treated as a picture. For example, subpic_treated_as_pic_flag[i] equal to a first value (e.g., 1) may specify that the i-th subpicture of each coded picture in the CLVS is treated as a picture in the decoding process excluding in-loop filtering operations. In contrast, subpic_treated_as_pic_flag[i] equal to a second value (e.g., 0) may specify that the i-th subpicture of each coded picture in the CLVS is not treated as a picture in the decoding process excluding in-loop filtering operations. When subpic_treated_as_pic_flag[i] is not present, the value of subpic_treated_as_pic_flag[i] may be inferred to be equal to sps_independent_subpics_flag.

When subpic_treated_as_pic_flag[i] is equal to a first value (e.g., 1), it is a requirement of bitstream conformance that all of the following conditions are true for each output layer and its reference layers in an OLS that includes the layer containing the i-th subpicture as an output layer:
(Condition 1): All pictures in the output layer and its reference layers shall have the same value of pic_width_in_luma_samples and the same value of pic_height_in_luma_samples.
(Condition 2): All the SPSs referred to by the output layer and its reference layers shall have the same value of sps_num_subpics_minus1 and shall have the same values of subpic_ctu_top_left_x[j], subpic_ctu_top_left_y[j], subpic_width_minus1[j], subpic_height_minus1 [j], and loop_filter_across_subpic_enabled_flag[j], respectively, for each value of j in the range of 0 to sps_num_subpics_minus1, inclusive.
(Condition 3): All pictures in each access unit in the output layer and its reference layers shall have the same value of SubpicIdVal[j] for each value of j in the range of 0 to sps_num_subpics_minus1, inclusive.

FIG. 5 is a view illustrating an example of a PPS.

Referring to FIG. 5, the PPS may include a syntax element no_pic_partition_flag, no_pic_partition_flag may specify whether picture partitioning is applied to each picture. For example, no_pic_partition_flag equal to a first value (e.g., 1) may specify that no picture partitioning is applied to each picture referring to the PPS. In contrast, no_pic_partition_flag equal to a second value (e.g., 0) may specify that each picture referring to the PPS may be partitioned into more than one tile or slice.

It is a requirement of bitstream conformance that the value of no_pic_partition_flag shall be the same for all PPSs that are referred to by coded pictures within a CLVS.

It is a requirement of bitstream conformance that the value of no_pic_partition_flag shall not be equal to 1 when the value of sps_num_subpics_minus1+1 is greater than 1.

In addition, the PPS may include a syntax element single_slice_per_subpic_flag. singe_slice_per_subpic_flag, may specify the number of slices in each subpicture. For example, single_slice_per_subpic_flag equal to a first value (e.g., 1) may specify that each subpicture consists of only one rectangular slice. single_slice_per_subpic_flag equal to a second value (e.g., 0) may specify that each subpicture may consist of one or more rectangular slices. When single_slice_per_subpic_flag is not present, the value of single_slice_per_subpic_flag is inferred to be equal to a second value (e.g., 0).

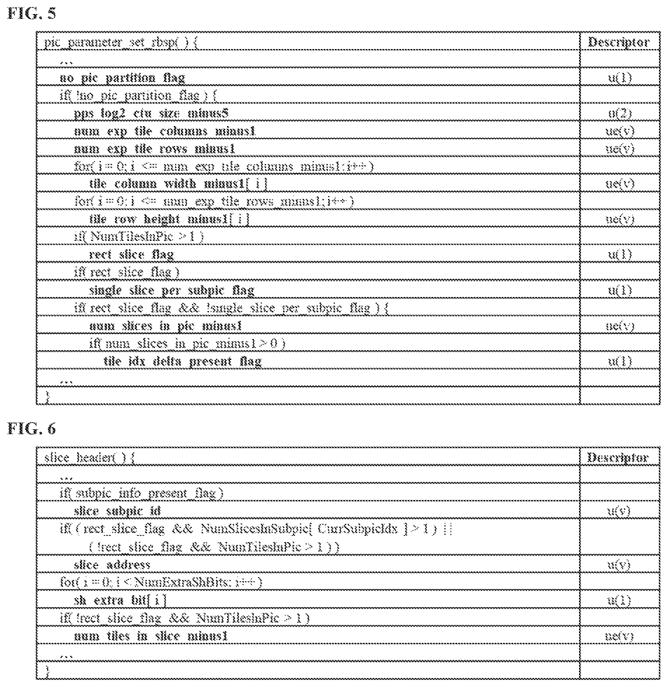

FIG. 6 is a view illustrating an example of a slice header.

Referring to FIG. 6, a slice header may include a syntax element num_tiles_in_slice_minus1. num_tiles_in_slice_minus1 plus 1 may specify the number of tiles in the slice. The value of num_tiles_in_slice_minus1 shall be in the range of 0 to NumTilesInPic-1, inclusive. Here, a variable NumTilesInPic may specify the number of tiles in the picture and may be set to a value obtained by multiplying the number of tile columns (e.g., NumTileColumns) by the number of tile rows (e.g. NumTileRows).

Signalling related to picture partitioning described above with reference to FIGS. 4 to 6 may have the following problems:

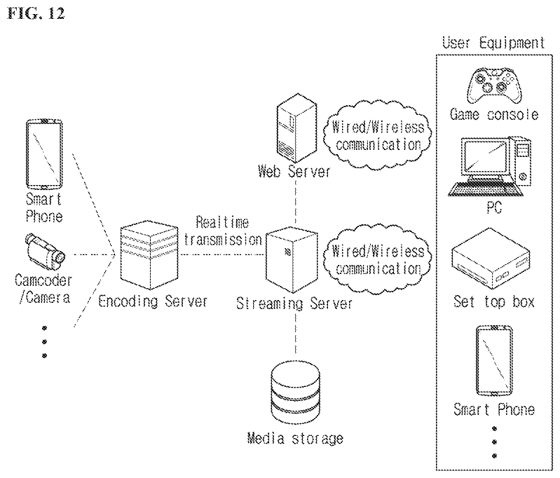

First, the individual signalling of no_pic_partition_flag and pps_num_subpics_minus1 is inefficient. When there is no picture partitioning (i.e., no_pic_partition_flag==1), it is obvious that the number of subpictures cannot be more than 1. Likewise, when there are more than two subpictures, it is obvious that there is picture partition so the value of no_pic_partition_flag cannot be equal to a first value (e.g., 1). Signalling of FIGS. 12 and 13 does not take such fact into consideration.

Second, the picture partitioning related signalling currently exists in both SPS and PPS and currently they may contradict each other. When no_pic_partition_flag is equal to a second value (e.g., 0) and the number of tiles in the picture is equal to 1, it is currently possible to set the value of single_slice_per_subpic_flag to be equal to a first value (e.g., 1) indicating that each subpicture consists of only one slice even when there is only 1 subpicture. Such setting would contradict the meaning of no_pic_partition_flag equal to a second value (e.g., 0), since this no_pic_partition_flag equal to a first value (e.g., 1) means that there is some kind of picture partitioning.

In order to solve the above problems, according to an embodiment of the present disclosure, in a predetermined higher level syntax (e.g., PPS), first information (e.g., no_pic_partition_flag) indicating whether there is picture partitioning or not may be signalled earlier than second information indicating the number of subpictures. When there is no picture partitioning, the second information may not be signalled. In this case, the second information shall have a value indicating that there is only one subpicture in each picture. Alternatively, when the second information indicates that the number of subpictures is greater than 1, the first information may not be signalled. In this case, the first information should be inferred to have a value indicating there is picture partitioning.

According to an embodiment of the present disclosure, when there is picture partitioning (e.g., no_pic_partition_flag==0), the number of tiles in the picture is equal to 1 and it is indicated that each subpicture contains only 1 slice (e.g., single_slice_per_subpic_flag==1), it is constrained that the number of subpictures in the picture shall be greater than 1. Alternatively, single_slice_per_subpic_flag may not be signalled when there is picture partitioning, the number of tiles is equal to 1, and the number of subpictures is equal to 1. In such case, the value of single_slice_per_subpic_flag shall be inferred to be equal to a second value (e.g., 0) indicating that each subpicture includes one or more slices.

Hereinafter, embodiments of the present disclosure will be described in greater detail with reference to the accompanying drawings.

### Embodiment 1

According to Embodiment 1, first information indicating whether there is picture partitioning and second information indicating the number of subpictures may be signalled together in the same syntax (e.g., PPS). In addition, the second information may be signalled only when there is picture partitioning (that is, conditional signaling).

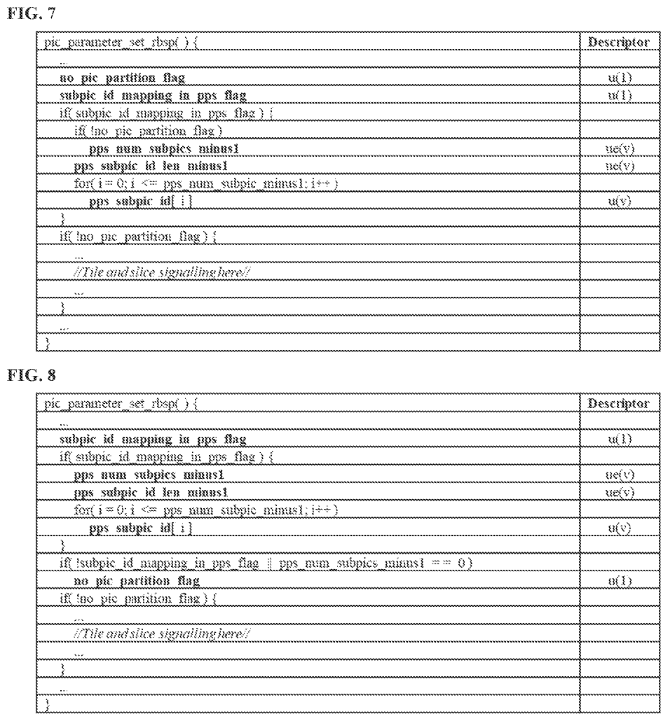

FIG. 7 is a view illustrating a PPS according to an embodiment of the present disclosure.

Referring to FIG. 7, the PPS may include no_pic_partition_flag as the first information. no_pic_partition_flag may specify whether picture partitioning is applied to each picture. For example, no_pic_partition_flag equal to a first value (e.g., 1) may specify that no picture partitioning is applied to each picture referring to the PPS. In contrast, no_pic_partition_flag equal to a second value (e.g., 0) may specify each picture referring to the PPS may be partitioned into more than one tile or slice.

It is a requirement of bitstream conformance that the value of no_pic_partition_flag shall be the same for all PPSs that are referred to by coded pictures within a CLVS.

It is a requirement of bitstream conformance that the value of no_pic_partition_flag shall not be equal to a first value (e.g., 1) when the number of subpictures in each picture is greater than 1 (e.g., sps_num_subpics_minus1+1>1). That is, when the number of subpictures in the picture is equal to or greater than 2, no_pic_partition_flag shall be equal to a second value (e.g., 0) indicating that picture partitioning is applied to the picture.

In addition, the PPS may include pps_num_subpics_minus1 as the second information. pps_num_subpics_minus1 plus 1 may specify the number of subpictures in each picture referring to the PPS. pps_num_subpics_minus1 may correspond to sps_num_subpics_minus1 in the SPS described above with reference to FIG. 13.

pps_num_subpics_minus1 may be signalled later than no_pic_partition_flag in the PPS. In addition, pps_num_subpics_minus1 may be signalled only when picture partitioning is applied to the picture. For example, when no_pic_partition_flag is equal to a first v lue (e.g., 1), pps_num_subpics_minus1 may not be signalled. In contrast, when no_pic_partition_flag is equal to a second value (e.g., 0), pps_num_subpics_minus1 may be signalled. Therefore, even though there is no picture partitioning (i.e., no_pic_partition_flag1), signaling of the second information as a value contradicting the first information (e.g., pps_num_subpics_minus1=2) may be prevented. When pps_num_subpics_minus1 is not signalled, the value of pps_num_subpics_minus1 may be inferred to be equal to a second value (e.g., 0).

According to Embodiment 1, the first information (e.g., no_pic_partition_flag) indicating whether there is picture partitioning and the second information (e.g., pps_num_subpics_minus1) indicating the number of subpictures may be signalled in one syntax (e.g., PPS). In this case, the first information may be signalled earlier than the second information, and, when the first information specifies that there is no picture partitioning, the second information may not be signalled. Therefore, compared to the case where the first information and the second information are individually signalled in different syntaxes, it is possible to improve signaling efficiency and to eliminate the possibility of occurrence of contradiction.

### Embodiment 2

According to Embodiment 2, first information indicating whether there is picture partitioning and second information indicating the number of subpictures nay be signalled together in the same syntax (e.g., PPS). In addition, the first information may not be signalled under a predetermined condition when the number of subpictures in the picture is greater than 1.

FIG. 8 is a view illustrating a PPS according to an embodiment of the present disclosure.

Referring to FIG. 8, the PPS may include a syntax element subpic_id_mapping_in_pps_flag. subpic_id_mapping_in_pps_flag may specify whether subpicture ID mapping is signalled in the PPS. For example, subpic_id_mapping_in_pps_flag equal to a first value (e.g., 1) may specify that subpicture ID mapping is signalled. In contrast, subpic_id_mapping_in_pps_flag equal to a second value (e.g., 0) may specify that subpicture ID mapping is not signalled. Here, subpicture ID mapping may mean that different identifiers are assigned to the respective subpictures in order to identify a plurality of subpictures.

In addition, the PPS may include a syntax element pps_num_subpics_minus1. pps_num_subpics_minus1 plus 1 may specify the number of subpictures in each picture referring to the PPS. pps_num_subpics_minus1 may correspond to sps_num_subpics_minus1 in the SPS described above with reference to FIG. 13.

pps_num_subpics_minus1 may be signalled only when subpic_id_mapping_in_pps_flag is equal to a first value (e.g., 1). That is, when subpicture ID mapping is not signalled in the PPS (i.e. subpic_id_mapping_in_pps_flag==0), pps_num_subpics_minus1 may not be signalled.

In addition, the PPS may include a syntax element no_pic_partition_flag. no_pic_partition_flag may specify whether picture partitioning is applied to each picture. For example, no_pic_partition_flag equal to a first value (e.g., 1) may specify that no picture partitioning is applied to each picture referring to the PPS. In contrast, no_pic_partiton_flag equal to a second value (e.g., 0) may specify that each picture referring to the PPS may be partitioned into more tian one tile or slice. When no_pic_partition_flag is not signalled, the value of no_pic_partition_flag is inferred to be equal to a second value (e.g., 0).

It is a requirement of bitstream conformance that the value of no_pic_partition_flag shall be the same for all PPSs that are referred to by coded pictures within a CLVS. It is a requirement of bitstream conformance that the value of no_pic_partition_flag shall not be equal to a first value (e.g., 1) when the value of sps_num_subpics_minus1+1 is greater than 1.

Meanwhile, no_pic_partition_flag may be restrictively signalled under a predetermined condition. For example, no_pic_partition_flag may be signalled only when subpic_id_mapping_in_pps_flag is equal to a second value (e.g., 0) or when pps_num_subpics_minus1 is 0. This may mean that, when the number of subpictures in the picture is greater than 1, it may mean that no_pic_partition_flag is not signalled based on subpicture ID mapping being signalled in the PPS. In this respect, Embodiment 2 is different from Embodiment 1 in in which no_pic_partition_flag is unconditionally signalled. Meanwhile, when no_pic_partition_flag is not signalled, no_pic_partition_flag shall be equal to a second value (e.g., 0) indicating that there is picture partitioning.

According to Embodiment 2, the first information (e.g., no_pic_partition_flag) indicating whether there is picture partitioning and the second information (e.g., pps_num_subpics_minus1) indicating the number of subpictures may be signalled in one syntax (e.g., PPS). In this case, the first information may not be signalled based on the number of subpictures in the picture being greater than 1. Therefore, compared to the case where the first information and the second information are individually signalled in different syntaxes, it is possible to improve signaling efficiency and to eliminate the possibility of occurrence of contradiction.

### Embodiment 3

According to Embodiment 3, when there is picture partitioning, the number of tiles in the picture is 1 and each subpicture contains only one slice, the number of subpictures in the picture shall be greater than 1. Alternatively, when there is picture partitioning, the number of tiles in the picture is 1 and the number of subpictures is 1, information (e.g., single_slice_per_subpic_flag) indicating whether each subpicture contains only one slice may not be signalled. In this case, the information may be inferred to be equal to a second value (e.g., 0) indicating that each subpicture includes or more slices.

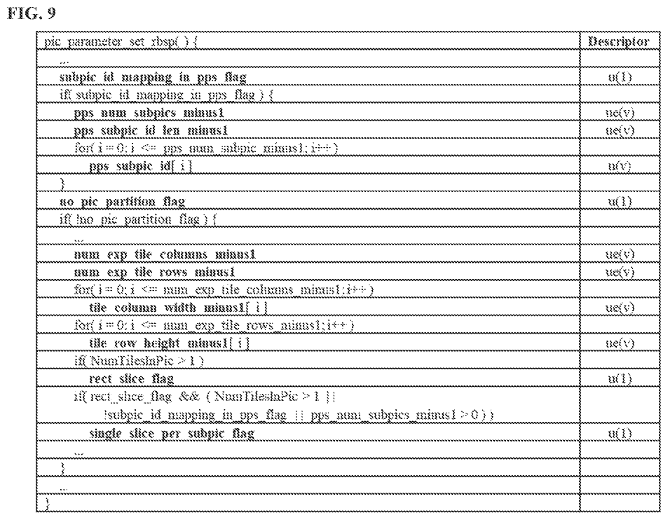

FIG. 9 is a view illustrating a PPS according to an embodiment of the present disclosure.

Referring to FIG. 9, the PPS may include a syntax element subpic_id__mapping_in_pps_flag. subpic_id_mapping_in_pps_flag specify whether subpicture TD mapping is signalled in the PPS.

In addition, the PPS may include a syntax element pps_num_subpics_minus1. The value of pps_num_subpics_minus1+1 may specify the nunber of subpictures in each picture referring to the PPS. pps_num_subpics_minus1 may be signalled only when subpic_id_mapping_in_pps_flag is equal to a first value (e.g., 1).

In addition, the PPS may include a syntax element no_pic_partition_flag. no_pic_partition_flag may specify whether picture partitioning is applied to each picture.

The semantics of subpic_id_mapping_in_pps_flag, pps_num_subpics_minus1 and no_pic_partition_flag were described above with reference to FIG. 16.

In addition, the PPS may include single_slice_per_subpic_flag as the third information. sigle_slice_per_subpic_flag, may specify whether each subpicture includes only one rectangular slice. For example, single_slice_per_subpic_flag equal to a first value (e.g., 1) may specify that each subpicture includes only one rectangular slice. In contrast, single_slice_per_subpic_flag equal to a second value (e.g., 0) may specify that each subpicture may include one or more rectangular slices. When single_slice_per_subpic_flag is not signalled, the value of single_slice_per_subpic_flag, may be inferred to be equal to a second value (e.g., 0).

In an embodiment, when no_pic_partition_flag is equal to a second value (e.g., 0), NumTilesInPic is 1, and single_slice_per_subpic_flag is equal to a first value (e.g., 1), the number of subpictures in the picture shall be greater than 1 (i.e., pps_num_subpics_minus1>0). Here, a variable NumTilesInPic may indicate the number of tiles in the picture and may be set to a value obtained by multiplying the number of tile columns (e.g., NumTileColumns) by the number of tile rows (e.g. NumTileRows). The above-described constraint may be a constraint for bitstream conformance.

In addition, in an embodiment, when no_pic_partition_flag is equal to a second value (e.g., 0), NumTilesInPic is 1 and pps_num_subpics_minus1 is 0, single_slice_per_subpic_flag may not be signalled. In this case, the value of single_slice_per_subpic_flag shall be inferred to be equal to a second value (e.g., 0).

Meanwhile, single_slice_per_subpic_flag may be restrictively signalled according to a predetermined condition. Specifically, single_slice_per_subpic_flag may be signalled only when both the following first and second conditions are true.
(First condition): no_pic_partition_flag=0
(Second condition): rect_slice_flag=1 && (NumTilesInPic>1 subpic_id_mapping_in_pps_flag==0∥pps_num_subpics_minus1>0)

In the second condition, rect_slice_flag equal to a second value (e.g., 0) may specify that tiles within each slice are in raster scan order and the slice information is not signalled in the PPS. In contrast, rect_slice_flag equal to a first value (e.g., 1) may specify that tiles within each slice cover a rectangular region of the picture and the slice information is signalled in the PPS. When rect_slice_flag is not signalled, rect_slice_flag may be inferred to be equal to a first value (e.g., 1). When subpic_info_present_flag is equal to a first value (e.g., 1), the value of rect_slice_flag shall be equal to a first value (e.g., 1).

According to Embodiment 3, information (e.g., pps_num_subpics_minus1) indicating the number of subpictures shall indicate that the picture includes a plurality of subpictures under a predetermined condition. Alternatively, information (e.g., single_slice_per_subpic_flag) indicating whether each subpicture contains only one slice shall be inferred to be equal to a second value (e.g., 0) indicating that each subpicture contains one or more slices under a predetermined condition. Therefore, it is possible to the possibility of occurrence of contradiction between the information on picture partitioning and the information on the number of subpictures.

Hereinafter, an image encoding/decoding method according to embodiments of the present disclosure will be described.

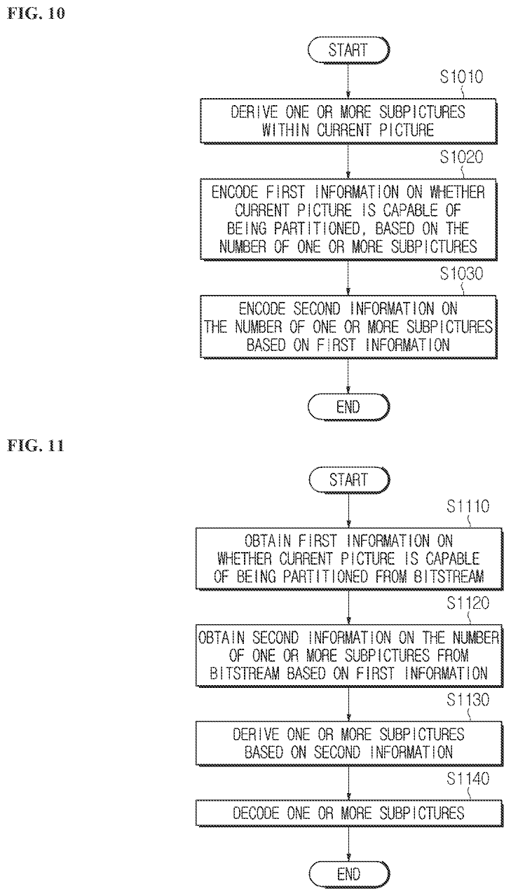

FIG. 10 is a flowchart illustrating an image encoding method according to an embodiment of the present disclosure. The image encoding method of FIG. 10 may be performed by the image encoding apparatus of FIG. 2.

Referring to FIG. 10, the image encoding apparatus may derive one or more subpictures included in a current picture (S1010). For example, The image encoding apparatus may derive one or more subpictures by dividing the current picture into subpicture units. Each subpicture within a picture may constitute a predetermined rectangular region. In addition, sizes of subpictures within a picture may be set in various ways. For example, all of the subpictures may have the same size, or at least some of the subpictures may have different sizes. In one example, within a picture, tiles and slices may be constrained not to span across the boundaries of each subpicture. To this end, the image encoding apparatus may perform encoding so that each subpicture is independently decoded.

The image encoding apparatus may generate first information (or picture partitioning information) indicating whether the current picture is partitioned based on the number of one or more subpictures included in the current picture (S1020). In an embodiment, the first information may include no_pic_partition_flag described above with reference to FIGS. 7 to 9. When only one subpicture is derived from the current picture, first information (e.g., no_pic_partition_flag) may be equal to a first value (e.g., 1) indicating that the current picture is not partitioned. In contrast, when two or more subpictures are derived from the current picture, no_pic_partition_flag may be equal to a second value (e.g., 0) indicating that the current picture is capable of being partitioned.

In an embodiment, it may be a requirement for bitstream conformance that the value of first information (e.g., no_pic_partition_flag) may be constrained to have the same value (e.g., − or 1) for all picture parameter sets referred to by coded pictures in the CLVS (coded layer video sequence).

In an embodiment, based on the number of subpictures included in the current picture being equal to or greater than 2 (e.g., pps_num_subpics_mrius1+1>1) first information (e.g., no_pic_partition_flag) may have a second value (e.g., 0) indicating that the current picture is capable of being partitioned.

The image encoding apparatus may encode second information regarding the number of one or more subpictures included in the current picture based on the above-described first information (S1030). In an embodiment, the second information may include pps_num_subpics_minus1 described above with reference to FIGS. 7 to 9.

In an embodiment, based on the first information (e.g., no_pic_partition_flag) 28aving a first value (e.g., 1) indicating that the current picture is not split, the second information (e.g. pps_num_subpics_minus1) may not be coded.

In an embodiment, the second information (e.g., pps_num_subpics_minus1) may be encoded in a picture parameter set together with the above-described first information (e.g., no_pic_partition_flag).

In an embodiment, based on the first information (e.g., no_pic_partition_flag) having a second value (e.g., 0) indicating that the current picture is capable of being partitioned, the current picture including one tile, and each one or more subpictures within the current picture including only one slice (e.g., single_slice_per_subpic_flag==1), the second information (e.g., pps_num_subpics_minus1) may have a predetermined value indicating that the number of the one or more subpictures is greater than one (e.g., e.g., 1).

In an embodiment, based on the first information (e.g., no_pic_partition_flag) having a second value (e.g., 0) indicating that the current picture is capable of being partitioned, the current picture including one tile, and the number of one or more subpictures included in the current being one, the third information (e.g., single_slice_per_subpic_flag) indicating the number of slices included in each of the one or more subpictures may have a first value (e.g., 1) indicating that each of the one or more subpictures includes only one slice.

The image encoding apparatus may generate a bitstream including at least one of first information (e.g., no_pic_partition_flag) to third information (e.g., single_slice_per_subpic_flag). The bitstream may be stored in a computer-readable recording medium, and may be transmitted to an image decoding apparatus through the recording medium or a network.

FIG. 11 is a flowchart illustrating an image decoding method according to an embodiment of the present disclosure. The image decoding method of FIG. it may be performed by the image decoding apparatus of FIG. 3.

Referring to FIG. 11, the image decoding apparatus may obtain first information on whether a current picture is capable of being partitioned from a bitstream (S1110). The first information may include no_pic_partition_flag described above with reference to FIGS. 7 to 9.

In an embodiment, the first information (e.g., no_pic_partition_flag) may have a second value (e.g., 0) indicating the current picture is capable of being partitioned based on the number of one or more subpictures included in the current picture being two or more (e.g., sps_num_subpics_minus1+1>1).

In an embodiment, the first information (e.g. no_pic_partition_flag) may have a second value (e.g., 0) indicating that the current picture is capable of being partitioned, based on the first information being not obtained from the bitstream.

The image decoding apparatus may obtain second information on the number of one or more subpictures included in the current picture from the bitstream based on the first information (S1120). In an embodiment, the second information may include pps_num_subpics_minus1 described above with reference to FIGS. 7 to 9.

In an embodiment, based on the first information (e.g., no_pic_partition_flag) having a first value (e.g., 1) indicating that the current picture is not partitioned, the second information (e.g., pps_num_subpics_minus1) is not obtained from the bitstream, and may have a predetermined value (e.g., 0) indicating that the number of one or more subpictures in the current picture is one.

In an embodiment, the second information (e.g., pps_num_subpics_minus1) may be obtained from a picture parameter set together with the above-described first information (e.g., no_pic_partition_flag).

In an embodiment, based on the first information (e.g., no_pic_partition_flag) having a second value (e.g., 0) indicating that the current picture is capable of being partitioned, the current picture including one tile, and each of one or more subpictures included in the current picture including only one slice (e.g., single_slice_per_subpic_flag=1), the second information (e.g., pps_num_subpics_minus1) is a predetermined value indicating that the number of the one or more subpictures is greater than one.

In an embodiment, based on the first information (e.g., no_pic_partition_flag) having a second value (e.g., 0) indicating that the current picture is capable of being partitioned, the current picture including one tile, and the number of one or more subpictures included in the current picture being one, the third information (e.g., single_slice_per_subpic_flag) indicating the number of slices included in each of the one or more subpictures is, may have a first value (e.g., 1) indicating that each of the one or more subpictures includes only one slice.

The image decoding apparatus may derive one or more subpictures included in the current picture based on the second information (S1130). For example, the image decoding apparatus may derive one or more subpictures in the current picture by dividing the current picture into subpicture units based on the number of subpictures indicated by the second information. In this case, each subpicture may have a unique subpicture identifier (e.g., pps_subpic_id[i]), and the subpicture identifier may have a predetermined length (e.g., pps_subpic_id_len_minus1+1 bits).

The image decoding apparatus may decode the one pr more subpictures in the current picture (S1140). The image decoding apparatus may decode the subpictures based on a CABAC method, a prediction method, a residual processing method (transform and quantization), and/or an in-loop filtering method. In addition, the image decoding apparatus may output the decoded subpictures.

According to the embodiments of the present disclosure, the first information (e.g., no_pic_partition_flag) on whether there is picture partitioning and the second information (e.g., pps_num_subpics_minus1) specifying the number of subpictures may be signalled in one syntax (e.g., PPS). In this case, the first information may be signalled d earlier than the second information. In addition, when the first information specifies that there is no picture partitioning, the second information may not be signalled. Therefore, compared to the case where the first information and the second information are individually signalled in different syntaxes, it is possible to improve signaling efficiency and to eliminate the possibility of occurrence of contradiction.

The name of the syntax element described in the present disclosure may include information on a position where the corresponding syntax element is signaled. For example, a syntax element starting with “sps_” may mean that the corresponding syntax element is signaled in a sequence parameter set (SPS). In addition, a syntax element starting with “pps_”, “ph_”, “sh_” may mean that the corresponding syntax element is signaled in a picture parameter set (PPS), a picture header and a slice header, respectively.

While the exemplary methods of the present disclosure described above are represented as a series of operations for clarity of description, itis not intended to limit the order in which the steps are performed, and the steps may be performed simultaneously or in different order as necessary. In order to implement the method according to the present disclosure, the described steps may further include other steps, may include remaining steps except for some of the steps, or may include other additional steps except for some steps.

In the present disclosure, the image encoding apparatus or the image decoding apparatus that performs a predetermined operation (step) may perform an operation (step) of confirming an execution condition or situation of the corresponding operation (step). For example, if it is described that predetermined operation is performed when a predetermined condition is satisfied, the image encoding apparatus or the image decoding apparatus may perform the predetermined operation after determining whether the predetermined condition is satisfied.

The various embodiments of the present disclosure are not a list of all possible combinations and are intended to describe representative aspects of the present disclosure, and the matters described in the various embodiments may be applied independently or in combination of two or more.

Various embodiments of the present disclosure may be implemented in hardware, firmware, software, or a combination thereof. In the case of implementing the present disclosure by hardware, the present disclosure can be implemented with application specific integrated circuits (ASICs), Digital signal processors (DSPS), digital signal processing devices (DSPDs), programmable logic devices (PLDs), field programmable gate arrays (FPGAs), general processors, controllers, microcontrollers, microprocessors, etc.

In addition, the image decoding apparatus and the image encoding apparatus, to which the embodiments of the present disclosure are applied, may be included in a multimedia broadcasting transmission and reception device, a mobile communication terminal, a home cinema video device, a digital cinema video device, a surveillance camera, a video chat device, areal time communication device such as video communication, a mobile streaming device, a storage medium, a camcorder, a video on demand (VoD) service providing device, an OTT video (over the top video) device, an Internet streaming service providing device, a three-dimensional (3D) video device, a video telephony video device, a medical video device, and the like, and may be used to process video signals or data signals. For example, the OTT video devices may include a game console, a Blu-ray player, an Internet access TV, a home theater system, a smartphone, a tablet PC, a digital video recorder (DVR), or the like.

FIG. 12 is a view illustrating a content streaming system, to which an embodiment of the present disclosure is applicable.

As shown in FIG. 12, the content streaming system, to which the embodiment of the present disclosure is applied, may largely include an encoding server, a streaming server, a web server, a media storage, a user device, and a multimedia input device.

The encoding server compresses content input from multimedia input devices such as a smartphone, a camera, a camcorder, etc. into digital data to generate a bitstream and transmits the bitstream to the streaming server. As another example, when the multimedia input devices such as smartphones, cameras, camcorders, etc. directly generate a bitstream the encoding server may be omitted.

The bitstream may be generated by an image encoding method or an image encoding apparatus, to which the embodiment of the present disclosure is applied, and the streaming server may temporarily store the bitstream in the process of transmitting or receiving the bitstream.

The streaming server transmits the multimedia data to the user device based on a user's request through the web server, and the web server serves as a medium for informing the user of a service. When the user requests a desired service from the web server, the web server may deliver it to a streaming server, and the streaming server may transmit multimedia data to the user. In this case, the content streaming system may include a separate control server. In is case, the control server serves to control a command/response between devices in the content streaming system.

The streaming server may receive content from a media storage and/or an encoding server. For example, when the content is received from the encoding server, the content may be received in real time. In this case, in order to provide a smooth streaming service, the streaming server may store the bitstream for a predetermined time.

Examples of the user device may include a mobile phone, a smartphone, a laptop computer, a digital broadcasting terminal, a personal digital assistant (PDA), a portable multimedia player (PMP), navigation, a slate PC, tablet PCs, ultrabooks, wearable devices (e.g., smartwatches, smart glasses, head mounted displays), digital TVs, desktops computer, digital signage, and the like.

Each server in the content streaming system may be operated as a distributed server, in which case data received from each server may be distributed.

The scope of the disclosure includes software or machine-executable commands (e.g., an operating system, an application, firmware, a program, etc.) for enabling operations according to the methods of various embodiments to be executed on an apparatus or a computer, a non-transitory computer-readable medium having such software or commands stored thereon and executable on the apparatus or the computer.

### INDUSTRIAL APPLICABILITY

The embodiments of the present disclosure may be used to encode or decode an image.

1. An image decoding method performed by an image decoding apparatus, the image decoding method comprising:
obtaining first information on whether a current picture might be partitioned, from a bitstream;
obtaining, from the bitstream, second information on the number of one or more subpictures included in the current picture based on the first information;
deriving one or more subpictures, based on the second information; and
decoding the one or more subpictures.

2. The image decoding method of claim 1, wherein, based on the first information having a first value indicating that the current picture is not partitioned, the second information is not obtained for the bitstream and has a predetermined value indicating that the number of the subpictures is 1.

3. The image decoding method of claim 1, wherein the first information and the second information are included in a picture parameter set.

4. The image decoding method of claim 1, wherein, based on the number of the one or more subpictures being two or more, the first information has a second value indicating that the current picture might be partitioned.

5. The image decoding method of claim 1, wherein, based on the first information having a second value indicating that the current picture might be partitioned, the current picture containing one tile and each of the one or more subpictures containing one slice, the second information has a predetermined value indicating that the number of the subpictures is greater than 1.

6. The image decoding method of claim 1, wherein, based on the first information having a second value indicating that the current picture might be partitioned, the current picture containing one tile and the number of one or more subpictures being 1, third information has a first value indicating that each of the one or more subpictures includes one slice.

7. The image decoding method of claim 1, wherein, based on the first information being not obtained from the bitstream, the first information has a second value indicating that the current picture might be partitioned.

8. (canceled)

9. An image encoding method performed by an image encoding apparatus, the image encoding method comprising:
deriving one or more subpictures included in a current picture;
encoding first information indicating whether the current picture might be partitioned, based on the number of the one or more subpictures; and
encoding second information on the number of the one or more subpictures, based on the first information.

10. The image encoding method of claim 9, wherein the second information is not encoded based on the first information having a first value indicating that the current picture is not partitioned.

11. The image encoding method of claim 9, wherein the first information and the second information are included in a picture parameter set.

12. The image encoding method of claim 9, wherein, based on the number of the one or more subpictures being two or more, the first information has a second value indicating that the current picture might be partitioned.

13. The image encoding method of claim 9, wherein, based on the first information having a second value indicating that the current picture might be partitioned, the current picture containing one tile and each of the one or more subpictures containing one slice, the second information has a predetermined value indicating that the number of the one or more subpictures is being greater than 1.

14. The image encoding method of claim 9, wherein, based on the first information having a second value indicating that the current picture might be partitioned, the current picture containing one tile and the number of the one or more subpictures being 1, third information indicating that the number of slices included in each of the one or more subpictures.

15. A non-transitory computer-readable recording medium storing a bitstream generated by the image encoding method of claim 9.

16. A method of transmitting a bitstream generated by an image encoding method, the image encoding comprising:
deriving one or more subpictures included in a current picture;
encoding first information indicating whether the current picture might be partitioned, based on the number of the one or more subpictures; and
encoding second information on the number of the one or more subpictures, based on the first information.
